(19) United States
(12) Patent Application Publication
(10) Pub. No.: US 2008/0003434 A1
(43) Pub. Date: Jan. 3, 2008

(54) Artificial hair fiber, artificial hair fiber bundle, hair decorative product, and a process for a preparation of an artificial hair fiber

(75) Inventors: Minoru Kuroda, Himeji-shi (JP); Kenichirou Cho, Kakogawa-shi (JP)

Correspondence Address: BRINKS HOFER GILSON & LIONE, P.O. BOX 10395, CHICAGO, IL, 60610, US

(73) Assignee: Kaneka Corporation :

(21) Appl. No.: 11/707,102

(22) Filed: Feb. 15, 2007

Related U.S. Application Data
(60) Provisional application No. 60/774,784, filed on Feb. 17, 2006.

(51) Int. Cl. D02G 3/44; B05D 3/10

(52) U.S. Cl. 428/378; 427/341

(57) ABSTRACT

The present invention relates to an antimicrobial artificial hair fiber, having favorable combing property and touch feeling and resistant to the deterioration of antimicrobial activity by shampooing, and an artificial hair fiber bundle and a hair decorative product using the same. The artificial hair fiber is an artificial hair fiber comprising a synthetic fiber, wherein the synthetic fiber is coated with a silicone, and at least one guanidine salt compound selected from polyhexamethylene biguanidine salt and polyhexamethylene guanidine salt is deposited on a surface of the silicone.

### TECHNICAL FIELD

The present invention relates to an artificial hair fiber superior in antimicrobial activity for use in hair decorative products.

### BACKGROUND ART

Conventionally, synthetic fibers have been used as artificial hair fibers.

Specifically, artificial hair fibers have been used in various hair decorative products such as weaving, wig, and extension for improvement in appearance, entire and partial wigs for covering sparse hair, and others. These hair decorative products are worn on head. Generally, there are sebaceous glands developed on the scalp of the head surface and thus are many resident microbiota growing on the scalp. As a result, extended use of a hair decorative product leads to moisturization of the head and easier proliferation of scalp-living microbes. Such proliferation of the scalp-living microbes caused problems of dandruff, itching, and foul odor.

To solve the problems above, Japanese Unexamined Patent Publication No. Hei 07-133586 discloses an artificial hair fiber containing zeolite blended therein as an antibacterial agent.

The synthetic fiber for use in artificial hair fibers is normally colored in the spinning step. When an antibacterial agent is blended in a synthetic fiber, the antimicrobial action is apparently exerted mainly by the antibacterial agent present on the surface, and thus, it is necessary to blend the antibacterial agent in a greater amount in the synthetic fiber, to make the antibacterial agent exposed on the surface. In such a case, there emerges a new problem of deterioration of coloration efficiency by irregular reflection of light on the surface by the antibacterial agent exposed on the synthetic fiber surface, which makes the surface uneven, and also by irregular reflection of the light entering into the synthetic fiber by the antibacterial agent contained therein. A blending of an antibacterial agent into the synthetic fiber also causes a problem of yarn breakage in the fiber-spinning step, leading to unstabilized production. The blending of an antibacterial agent into a synthetic fiber also causes a problem of deterioration of the fiber mechanical strength and thus easier yarn breakage during combing.

### DISCLOSURE OF THE INVENTION

An aspect of the present invention is an artificial hair fiber comprising a synthetic fiber, wherein the synthetic fiber is coated with a silicone, and at least one guanidine salt compound selected from polyhexamethylene biguanidine salt and polyhexamethylene guanidine salt is deposited on a surface of the silicone. The artificial hair fiber obtained by depositing the guanidine salt compound on the surface of the silicone coated on the synthetic fiber is resistant to the deterioration in antimicrobial activity by shampooing and superior in combing property and touch feeling.

Objects, features, aspects, and advantages of the present invention will become more apparent upon reading the following detailed description.

### BEST MODE FOR CARRYING OUT THE INVENTION

In order to solve the conventional problems above, the inventors have studied a method of depositing an antibacterial agent on the synthetic fiber surface by coating, and found that it was difficult to deposit an antibacterial agent on the fiber surface sufficiently only by coating the antibacterial agent on the synthetic fiber surface and that the surface-deposited antibacterial agent was easily eliminated by shampooing when a person wearing a hair decorative product of such a artificial hair fiber shampooed the hair decorative product, prohibiting long-term preservation of the antimicrobial activity.

To solve the problem of the release of the antibacterial agent by shampooing, the inventors have also studied a method of depositing an antibacterial agent dispersed in a water-resistant binder resin on the synthetic fiber surface. However, such a method resulted in problem of deterioration in touch feeling of the artificial hair fiber and combing property due to hardening and surface tackiness of the artificial hair fiber by deposition of the binder resin on the synthetic fiber surface.

Thus, it was difficult to obtain an artificial hair fiber that retains its favorable touch feeling and combing property, important properties as an artificial hair fiber, and yet resistant to the deterioration in antimicrobial activity by shampooing.

The aspect of the invention has been made in view of the above problems. It is an object of the present invention to provide an antimicrobial artificial hair fiber that retains its favorable touch feeling and combing property, important properties as an artificial hair fiber, and yet resistant to the deterioration in antimicrobial activity by shampooing, and an artificial hair fiber bundle and a hair decorative product by using the same.

Hereinafter, the embodiment according to the invention will be described specifically.

The artificial hair fiber of the embodiment comprises a synthetic fiber, wherein the synthetic fiber is coated with a silicone, and at least one guanidine salt compound selected from polyhexamethylene biguanidine salt and polyhexamethylene guanidine salt is deposited on a surface of the silicone.

Typical examples of the synthetic fibers include polyester fiber, acrylic fiber, polyvinyl chloride fiber, polyamide fiber and the like. Among them, particularly preferable are polyester fiber and acrylic fiber, because they are closer to human hair in touch feeling and appearance and superior in combing property and curling efficiency.

Typical examples of the polyester fibers include polyalkylene terephthalates such as polyethylene terephthalate, polypropylene terephthalate, and polybutylene terephthalate; copolymers of the polyalkylene terephthalate containing additionally a small amount of a copolymer component; and resin compositions containing a resin obtained by compounding the polyalkylene terephthalate or the copolymer polyester with polyarylate, polycarbonate, or the like.

Typical examples of the acrylic fibers include fibers of a resin composition containing an acrylic resin from acrylonitrile, a halogen-containing vinyl monomer and other copolymerizable monomer as its resin component.

Typical examples of the polyamide fibers include polyamides such as nylon 6, nylon 66, nylon 666, nylon 12, nylon 46, nylon 610, and nylon 612, and resin compositions containing, for example, a copolymeric polyamide mainly of the nylon above containing additionally a small amount of copolymer component as the resin composition.

The monofilament fineness of the synthetic fiber is preferably 20 to 150 dtex, more preferably 30 to 90 dtex, because of similarity in touch feeling, combing property, curling efficiency and others to human hair.

Examples of the silicones coated on the synthetic fiber surface include dimethyl silicone, methylphenyl silicone, methyl hydrogen silicone, amino-modified silicone, epoxy-modified silicone, carboxy-modified silicone, carbinol-modified silicone, methacrylic-modified silicone, mercapto-modified silicone, phenol-modified silicone, polyether-modified silicone, methylstyryl-modified silicone, alkyl-modified silicone, higher fatty ester-modified silicone, special hydrophilized silicone, higher fatty acid-containing silicone, fluorine-modified silicone and the like. Among them, at least one compound selected from dimethyl silicone and amino-modified silicones is preferably, because it is superior in touch feeling and favorable in combing property and improves the durability of the antimicrobial activity of the coated guanidine salt compound described below.

Silicone oils traditionally used as a textile-processing agent are preferable as the silicones for use in the embodiment, from the point of coating efficiency.

The amount of the silicon coated on the synthetic fiber surface may vary according to the kind of the silicone used, but is preferably approximately 0.01 to 0.5% omf, more preferably 0.01 to 0.3% omf, because it makes the artificial hair fiber particularly superior in touch feeling and combing property. An excessively smaller silicone-coating amount may lead to deterioration in combing property and touch feeling, while an excessively larger amount, to deterioration in combing property and touch feeling caused by tackiness feeling of the fibersurface.

The at least one guanidine salt compound selected from polyhexamethylene biguanidine salts and polyhexamethylene guanidine salts to be deposited on the silicone surface, which has superior antibacterial and antifungal activities, has an antimicrobial spectrum effective to a wide range of microbes.

Examples of the salts for the guanidine salt compound include hydrochloride salt, nitrate salt, formate salt, acetate salt, benzoate salt, dehydroacetate salt, propionate salt, gluconate salt, sorbate salt, phosphate salt, fumarate salt, maleate salt, carbonate salt, sulfate salt or p-toluenesulfonate salt and the like.

The number of the repeating “hexamethylene biguanidine units” or the “hexamethylene guanidine units” in the polyhexamethylene biguanidine salt or polyhexamethylene guanidine salt is preferably 2 to 5, more preferably 3 to 4, and particularly preferably 3, from the points of durability of the antimicrobial activity.

The depositing amount of the guanidine salt compound is preferably 0.001 to 1% omf, more preferably 0.01 to 0.5% omf, for prevention of the deterioration in antimicrobial activity by shampooing and further improvement in durability of the antimicrobial activity.

In the embodiment according to the invention, the mass ratio between the amounts of the silicone coated and the guanidine salt compound deposited (guanidine salt compound/silicone) is preferably 0.01 to 25, more preferably 0.1 to 10. A ratio in the range above is preferable, particularly from the point of the durability of antimicrobial activity.

Hereinafter, the method of producing the artificial hair fiber according to the present embodiment will be described.

The synthetic fiber used in the embodiment can be prepared by any synthetic fiber-spinning method known in the art such as melt spinning or solution spinning method.

Hereinafter, the melt spinning method will be described, taking polyester fiber as a typical example of the synthetic fiber for use in the embodiment.

The polyester fiber can be prepared by melt-spinning a polyester resin composition previously obtained by melt blending polyester resins and as needed other additives.

The inherent viscosity of the polyester resin is preferably 0.5 to 1.4, more preferably 0.6 to 1.2. An excessively lower inherent viscosity leads to deterioration of the mechanical strength of the fiber obtained, while an excessively higher viscosity to difficulty in melt spinning by increased melt viscosity of the resin by increase of molecular weight and consequently in adjusting the fiber fineness.

A flame retardant such as phosphorus-based flame retardant or bromine-based retardants may be added to the polyester resin composition for improvement in flame resistance. Examples of the phosphorus-based flame retardants include phosphate compounds, phosphonate compounds, phosphinate compounds, phosphine oxide compounds, phosphonite compounds, phosphinite compounds, phosphine compounds, condensed phosphate ester compounds, phosphate ester amide compounds, organic cyclic phosphorus compounds, and the like. Examples of the bromine-based flame retardants include bromine-containing phosphate esters, brominated polystyrenes, brominated polybenzyl acrylates, brominated epoxy oligomers, brominated polycarbonate oligomers, tetrabromobisphenol A derivatives, bromine-containing triazine compounds, bromine-containing isocyanuric acid compounds, and the like. These compounds may be used alone or in combination of two or more.

The content of the flame retardant is preferably 5 to 30 parts by weight, more preferably 6 to 25 parts by weight, and particularly preferably 7 to 20 parts by weight, with respect to 100 parts by weight of the polyester resin in the polyester resin composition. An excessively lower content leads to deterioration in flame retarding effect, while an excessively higher content to deterioration in mechanical strength, heat resistance, and dripping resistance.

In addition, a flame retardant aid may be added to the polyester resin composition together with a flame retardant for improvement of the flame-retarding effect. Typical examples of the flame retardant aids include melamine cyanurate, antimony trioxide, antimony tetroxide, antimony pentoxide, sodium antimonate, and the like, and these compounds may be used alone or in combination of two or more. The content of the flame retardant aid is preferably 10 parts or less by weight, more preferably 8 parts or less by weight, and particularly preferably 6 parts or less by weight, with respect to 100 parts by weight of the polyester resin. An excessive flame-retardant-aid content leads to deterioration in the processing stability during spinning and the appearance and transparency of the fiber.

Various additives such as matting agent, heat resistance improver, photostabilizer, fluorescent agent, antioxidant, antistatic agent, pigment, plasticizer, and lubricant may be added as needed to the polyester resin composition in the range that does not impair the advantageous effects of the present invention.

The polyester resin composition can be prepared by common melt blending. Examples of the blending machines used in melt blending include single-screw extruder, twin-screw extruder, roll, Banbury mixer, kneader, and the like. Among them, twin-screw extruders are preferable from the points of efficiency in adjusting blending ratio and easiness of operation.

The polyester fiber can be produced by melt-spinning the polyester resin composition obtained by melt blending, by a common melt spinning method.

Specifically, the polyester fiber is produced, for example, by melt spinning a polyester resin composition with an extruder equipped with a gear pump, a spinning die, and others previously set to a temperature of 250 to 310° C., allowing the spun yarn to pass through a heated tube, cooling the yarn to a temperature of not higher than its glass transition point, and winding the yarn at a velocity of 50 to 5,000 m/minute. The fineness of the spun yarn can be controlled by cooling the yarn in a water bath containing cooling water. The temperature and length of the heated tube the temperature and amount of the cooling air applied, the temperature of the cooling water bath, the cooling period, and the winding rate are adjusted properly according to the extrusion amount and the number of nozzles in the spinning die.

The undrawn yarn is then hot-drawn in any method, either by a two-step method of drawing the undrawn yarn once wound or by a direct drawing method of drawing the yarn directly without winding. The hot drawing may performed either by a singe-stage drawing or a multiple-stage drawing having two or more stages. Examples of the heating means during hot drawing include heating roller, heat plate, steam jet apparatus, hot water bath, and the like, and these means may be used in combination as needed.

Other fibers such as polyamide fiber, polyvinyl chloride fiber, and acrylic fiber can be produced by a known method such as melt spinning or solution spinning.

Then, silicone is coated on the surface of the synthetic fiber thus prepared for improvement of the durability of the antimicrobial activity of the guanidine salt compound and of the touch feeling and combing property. The silicone-coated synthetic fiber is obtained by coating a silicone solution on the surface of a synthetic fiber by immersing it in the silicone solution and removing the solvent by drying the fiber under heat.

The silicone solution is prepared by dissolving the silicone oil in a suitable solvent to a suitable concentration.

The amount of the silicone coated may be controlled by adjusting the amount of the silicone solution coated on the synthetic fiber and the concentration of the silicone solution during immersion. It is thus possible to coat a desirable amount of silicone on the synthetic fiber surface by removing the solvent by drying the silicone solution deposited on the synthetic fiber.

Then as described above, a guanidine salt compound is applied on the surface of the silicone on the synthetic fiber surface for providing an antimicrobial activity. The guanidine salt compound is applied by applying an aqueous solution of guanidine salt compound on the silicone surface by immersing the silicone-coated synthetic fiber in an aqueous solution containing a guanidine salt compound previously adjusted to a particular concentration, and then, withdrawing, dehydrating and drying the synthetic fiber.

The amount of the guanidine salt compound deposited can also be controlled by adjusting the amount of the aqueous solution of guanidine salt compound applied thereon by coating and the concentration of the aqueous solution of guanidine salt compound. It is thus possible to deposit a desirable amount of the guanidine salt compound on the silicone surface by drying the aqueous solution of guanidine salt compound applied on the silicone surface.

The heat treatment temperature during drying is not particularly limited, as it depends on the kind of the synthetic fiber, but preferably approximately 50 to 170° C., more preferably 80 to 150° C., for prevention of fiber damage and improvement of durability of the antimicrobial activity.

In particular when a polyester fiber is used, the heating temperature is preferably approximately 50 to 170° C., more preferably 90 to 150° C., for preservation of the durability of the antimicrobial activity, and prevention of the deterioration in properties needed for artificial hair fiber, such as appearance, touch feeling and combing property, by contraction of the synthetic fiber.

For the same reason, when acrylic fiber is used, the heating temperature is preferably 70 to 110° C., more preferably 80 to 100° C., and when polyvinyl chloride fiber is used, it is preferably approximately 70 to 90° C., more preferably 80 to 90° C. In addition, the heating period is preferably approximately 20 to 120 minutes, more preferably 30 to 60 minutes. An excessively shorter heating period may result in insufficient durability of the antimicrobial activity, while an elongated heating period may lead to hardening of the fiber and deterioration in the properties needed for artificial hair fiber such as appearance, touch feeling, and combing property, depending on the kind of the synthetic fiber.

In the embodiment, silicone is preferably coated additionally on the surface of the guanidine salt compound after application. Such a silicone film additionally formed improves the durability of the antimicrobial activity further.

The artificial hair fiber according to the embodiment thus obtained is favorable in combing property and touch feeling and resistant to the deterioration in antimicrobial activity by shampooing. Thus, the artificial hair fiber bundle of the artificial hair fiber according to the embodiment is suitable as a material for production of various hair decorative products superior in durability of antimicrobial activity as well as in combing property and touch feeling. The artificial hair fiber bundle shows the favorable effects above when it contains not only the artificial hair fiber according to the embodiment but also a blend thereof with other synthetic or natural hair fiber.

The artificial hair fiber bundle according to the embodiment can be used favorably in various hair decorative products, specifically, hair accessory such as weaving, extension and braid, wig, toupee, doll hair, and others, in particular as a raw hair material for hair accessory, wig, and toupee. The hair accessory is a general term for accessories excluding wigs connected directly to the natural hair or the scalp; the weaving is a hair decorative product mostly in the belt shape that is to be woven with natural hair along the scalp or connected to the scalp or natural hair for example with adhesive; and the extension is a hair decorative product to be connected to the natural hair, for example, with a hair pin or hair clip for making the natural hair appear longer. The wig is an accessory for both men and women improving the appearance as it is placed flat on the head, and the products are grouped depending on the contact area into partial wig, half wig, three-quarter wig, and full wig.

The hair decorative products are produced with the artificial hair fiber bundle according to the embodiment by a method known in the art. For example, a wig can be produced by preparing a weft prepared by sewing the fiber bundles with a sewing machine; heat-setting the weft in a dry oven or by steam as it is wound around a pipe or alternatively by heat-setting the weft with a hair iron; sewing the curled weft on a hair cap; and adjusting the style.

### EXAMPLES

Hereinafter, the present invention will be described more specifically with reference to Examples. It should be understood that the scope of the present invention is not limited by these Examples.

The raw materials used in the present Example are the follows:

(Synthetic Fiber)

PET fiber: a polyethylene terephthalate fiber having a monofilament fineness of approximately 65 dtex,
trade name: Kanecaron Futura, manufactured by Kaneka Corporation
Acrylic fiber: a modacrylic fiber having a monofilament fineness of approximately 51 dtex, trade name: Kanecaron FS-TEX, manufactured by Kaneka Corporation
PVC fiber: a polyvinyl chloride fiber having a monofilament fineness of approximately 78 dtex, trade name: Kanecaron ADR70, manufactured by Kaneka Corporation
   (Textile-Processing Agent)
Amino-modified silicone (trade name: KWC-Z, manufactured by Dow Corning Toray Silicone Co., Ltd.)
Dimethylsilicone (trade name: K-901, manufactured by Takemoto Oil & Fat Co., Ltd.)
Surfactant: mixture of sorbitan monostearate and polyoxyethylene caster oil ether, (trade name: KO-14, manufactured by Matsumoto Yushi-Seiyaku Co., Ltd.)
   (Antibacterial Agent)
Polyhexamethylene biguanidine hydrochloride salt (trade name: AA-2100K II, manufactured by Daiwa Chemical Industries Co., Ltd., having a hexamethylene biguanidine unit repetition number of 3)
Silver-containing zeolite fine powder (trade name: AA-2000S, manufactured by Daiwa Chemical Industries Co., Ltd.)
Phenylamide compound (trade name: Amorden MCM-400, manufactured by Daiwa Chemical Industries Co., Ltd.)

### Example 1

A PET fiber coated with an amino-modified silicone 0.22% omf and dimethyl silicone 0.05% omf on the surface was cut into short fibers of 500 mm in length. The PET fiber was bundled to a suitable total fineness; intermingle among the fibers was eliminated by hackling; and the fiber bundles were woven without disentanglement of the fiber bundles with a single-needle sewing machine. The woven fiber bundles were immersed in an aqueous solution of guanidine salt compound containing 75 g of polyhexamethylene biguanidine hydrochloride salt in 1 L of water for 5 minutes.

The immersion-processed fiber bundles was dehydrated by centrifugation to a water content of 15 wt % and heat-treated in a convection dryer at 60° C. for 60 minutes. Then, the fiber bundles were woven with a wig sewing machine, to give a weft.

The hairdressing properties and antimicrobial activity of the weft obtained were evaluated according to the following evaluation methods.

(Hairdressing Properties)

The appearance of a weft treated with an antibacterial agent was compared with that untreated therewith and evaluated according to the following criteria:

Visual Observation of Appearance:

Good: appearance similar to that of the weft untreated with an antibacterial agent.

Bad: precipitation of the white powdery antibacterial agent on the surface.

Combing Property:

Superior: combing property similar to that of the weft untreated with an antibacterial agent.

Unsatisfactory: less easily combed than the weft untreated with an antibacterial agent.

Bad: could not be combed, in contrast to the weft untreated with an antibacterial agent.

Touch Feeling:

Superior: touch feeling similar to that of the weft untreated with an antibacterial agent.

Unsatisfactory: harder than the weft untreated with an antibacterial agent.

Bad: tackier than the weft untreated with an antibacterial agent.

(Durability of Antimicrobial Activity)

In a model test for evaluation of the deterioration of the antimicrobial activity of a hair decorative product when it is place on the head and shampooed, the weft was washed with a washing solution containing 0.133 wt % detergent (JAFET detergent) for five minutes and rinsed with water twice for two minutes for a total of five times. The weft was dried indoor.

Separately, Staphylococcus aureus (Staphylococcus aureus NBRC 12732) was suspended in a sterilized nutrient broth liquid medium, according to the antimicrobial test method (JIS L-1902) established by the Japan Association for the Function Evaluation of Textile. 0.2 g of the artificial hair fiber obtained by cutting the selected weft was placed in 0.2 milliliter of the suspension; the mixture was incubated at a temperature of 37° C. for 18 hours; and the viable cell counts on the test sample before and after incubation was determined. The bacteriostatic activity was then calculated according to the following equation, and the durability of antimicrobial activity was evaluated. A bacteriostatic activity of 2.2 or more is regarded as positive antimicrobial activity, and a greater value means higher antimicrobial activity.

Calculation of Activity

Average of the viable count on antimicrobially-untreated weft after 18 hours: [A]

Average of the viable count on antimicrobially-treated weft after 18 hours: [B]
Bacteriostatic activity=Log [A]−Log [B]

Results are summarized in Table 1.

### Examples 2 to 8

Wefts were prepared and evaluated in a similar manner to Example 1, except that the content of the aqueous solution of polyhexamethylene biguanidine hydrochloride salt in the fiber was so adjusted by centrifugation dehydration that the coating amount of the antibacterial agent becomes the value shown in Table 1, and the weft was treated under the heat treatment condition shown in Table 1. Results are summarized in Table 1.

### Examples 9 and 10

Wefts were prepared and evaluated in a similar manner to Example 1, except that the convection dryer was replaced with a steam setter and the weft was treated under the heat treatment condition shown in Table 1. Results are summarized in Table 1.

### Example 11

A weft was prepared and evaluated in a similar manner to Example 1, except that an acrylic fiber coated with an amino-modified silicone in an amount of 0.02 omf % was used and the weft was treated under the heat treatment condition shown in Table 1. Results are summarized in Table 1.

TABLE 1

| | | | Example number | | | | | |
|---|---|---|---|---|---|---|---|---|
| | | | 1 | 2 | 3 | 4 | 5 | 6 |
| Synthetic fiber | Kind of fiber | | PET | PET | PET | PET | PET | PET |
| | Textile- | Amino- | 0.22 | 0.22 | 0.22 | 0.22 | 0.22 | 0.22 |
| | processing | modified | | | | | | |
| | agent | silicone | | | | | | |
| | | Dimethyl | 0.05 | 0.05 | 0.05 | 0.05 | 0.05 | 0.05 |
| | | silicone | | | | | | |
| Polyhexamethylene biguanidine | | | 0.16 | 0.16 | 0.04 | 0.08 | 0.12 | 0.16 |
| hydrochloride salt (% omf) | | | | | | | | |
| Heating condition | Convection | Heating | 60 | 90 | 110 | 110 | 110 | 110 |
| | drier | temperature | | | | | | |
| | | (° C.) | | | | | | |
| | | Heating | 60 | 60 | 60 | 60 | 60 | 60 |
| | | period (min) | | | | | | |
| | Steam | Steam | — | — | — | — | — | — |
| | setter | temperature | | | | | | |
| | | (° C.) | | | | | | |
| | | Steaming | — | — | — | — | — | — |
| | | period | | | | | | |
| | | (min) | | | | | | |

| | | | | | | | |
|---|---|---|---|---|---|---|---|
| Hairdressing | Visual observation of | Good | Good | Good | Good | Good | Good |
| properties | appearance | | | | | | |
| | Combing property | Superior | Superior | Superior | Superior | Superior | Superior |
| | Touch feeling | Superior | Superior | Superior | Superior | Superior | Superior |

| | | | | | | |
|---|---|---|---|---|---|---|
| Durability of antimicrobial activity | 3.8 | 4.6 | 4.9 | 5.9 | 5.9 | 6.0 |
| (bacteriostatic activity) | | | | | | |

| | | | Example number | | | | |
|---|---|---|---|---|---|---|---|
| | | | 7 | 8 | 9 | 10 | 11 |
| Synthetic fiber | Kind of fiber | | PET | PET | PET | PET | Acrylic |
| | Textile- | Amino- | 0.22 | 0.22 | 0.22 | 0.22 | 0.02 |
| | processing | modified | | | | | |
| | agent | silicone | | | | | |
| | | Dimethyl | 0.05 | 0.05 | 0.05 | 0.05 | — |
| | | silicone | | | | | |
| Polyhexamethylene biguanidine | | | 0.32 | 0.16 | 0.16 | 0.16 | 0.16 |
| hydrochloride salt (% omf) | | | | | | | |
| Heating condition | Convection | Heating | 110 | 110 | — | — | 80 |
| | drier | temperature | | | | | |
| | | (° C.) | | | | | |
| | | Heating | 60 | 30 | — | — | 60 |
| | | period (min) | | | | | |
| | Steam | Steam | — | — | 110 | 110 | — |
| | setter | temperature | | | | | |
| | | (° C.) | | | | | |
| | | Steaming | — | — | 30 | 60 | — |
| | | period | | | | | |
| | | (min) | | | | | |

| | | | | | | |
|---|---|---|---|---|---|---|
| Hairdressing | Visual observation of | Good | Good | Good | Good | Good |
| properties | appearance | | | | | |
| | Combing property | Superior | Superior | Superior | Superior | Superior |
| | Touch feeling | Superior | Superior | Superior | Superior | Superior |

| | | | | | |
|---|---|---|---|---|---|
| Durability of antimicrobial activity | 5.7 | 3.5 | 5.6 | 6.0 | 5.6 |
| (bacteriostatic activity) | | | | | |

### Examples 12 to 14

Wefts were prepared by using a fiber bundle of mixed artificial hair fibers in the fiber composition shown in Table 2 and evaluated in a similar manner to Example 1. The PET fiber used in Examples 12 to 14 was artificial hair fiber obtained in Example 6. The PVC fiber used was not coated. In addition, an acrylic fiber coated with a 0.02% omf amino-modified silicone but not with a biguanidine salt compound (acrylic fiber A) and, an acrylic fiber coated with a 0.25% omf surfactant but not with a biguanidine salt compound (acrylic fiber B) were used. Results are summarized in Table 2.

TABLE 2

| | | Example number | | |
|---|---|---|---|---|
| | | 12 | 13 | 14 |
| Fiber composition | Artificial hair fiber of PET fiber | 70 | 30 | 40 |
| (mass %) | prepared in a similar manner to | | | |
| | Example 6 | | | |
| | PVC fiber (not coated with | 30 | 70 | — |
| | processing agent or biguanidine | | | |
| | salt compound) | | | |
| | Acrylic fiber A coated with | — | — | 30 |
| | 0.02% omf amino-modified silicone | | | |
| | (not coated with biguanidine salt | | | |
| | compound) | | | |
| | Acrylic fiber B coated with | — | — | 30 |
| | 0.25% omf surfactant | | | |
| | (not coated with biguanidine salt | | | |
| | compound) | | | |
| Hairdressing properties | Visual observation of appearance | Good | Good | Good |
| | Combing property | Superior | Superior | Superior |
| | Touch feeling | Superior | Superior | Superior |

| | | | |
|---|---|---|---|
| Durability of antimicrobial activity (bacteriostatic activity) | 6.0 | 4.4 | 3 |

### Comparative Example 1

A weft was prepared and evaluated in a similar manner to Example 7, except that a PET fiber not coated with silicone was used as the fiber. Results are summarized in Table 3.

### Comparative Examples 2 and 3

Wefts were prepared and evaluated in a similar manner to Example 1, except that the antibacterial agent shown in Table 3 was coated in the coating amount shown in Table 3 and the wefts were heated at the temperature shown in Table 3. Results are summarized in Table 3.

### Comparative Examples 4 to 6

Wefts were prepared and evaluated in a similar manner to Example 1, except that the synthetic fiber shown in Table 3 was used and not coated with an antibacterial agent. Results are summarized in Table 3.

### Comparative Example 7

A weft was prepared and evaluated in a similar manner to Example 1, except that the acrylic fiber coated with a surfactant shown in Table 3 was used as the fiber and additionally coated with 0.16% omf polyhexamethylene biguanidine hydrochloride salt and the weft was heated at the temperature shown in Table 3. Results are summarized in Table 3.

TABLE 3

| | | | Comparative Example number | | | | | | |
|---|---|---|---|---|---|---|---|---|---|
| | | | 1 | 2 | 3 | 4 | 5 | 6 | 7 |
| Synthetic | Kind of fiber | | PET | PET | PET | PET | PVC | Acrylic | Acrylic |
| fiber | Textile-processing | Amino-modified | — | 0.22 | 0.22 | 0.22 | — | — | — |
| | agent (omf %) | silicone | | | | | | | |
| | | Dimethyl | — | 0.05 | 0.05 | 0.05 | — | — | — |
| | | silicone | | | | | | | |
| | | Surfactant | — | — | — | — | — | 0.25 | 0.25 |
| Antibacterial | Polyhexamethylene biguanidine | | 0.32 | — | — | — | — | — | 0.16 |
| agent-coating | hydrochloride salt | | | | | | | | |
| amount | Silver-containing zeolite fine | | — | 0.24 | — | — | — | — | — |
| (omf %) | powder | | | | | | | | |
| | Phenylamide-based compound | | — | — | 0.45 | — | — | — | — |
| Heating | Convection dryer | Heating | 110 | 110 | 110 | — | — | — | 80 |
| condition | | temperature | | | | | | | |
| | | (° C.) | | | | | | | |
| | | Heating period | 60 | 60 | 60 | — | — | — | 60 |
| | | (min) | | | | | | | |

| | | | | | | | | |
|---|---|---|---|---|---|---|---|---|
| Hairdressing | Visual observation of appearance | Good | Bad | Good | Good | Good | Good | Good |
| properties | Combing property | Unsatisfactory | Bad | Bad | Superior | Superior | Superior | Superior |
| | Touch feeling | Unsatisfactory | Bad | Bad | Superior | Superior | Superior | Superior |

| | | | | | | | |
|---|---|---|---|---|---|---|---|
| Durability of antimicrobial activity | Unevaluated | Unevaluated | Unevaluated | 1.5 | 2 | 0.8 | 0.3 |
| (bacteriostatic activity) | | | | | | | |

The results in Examples and Comparative Examples indicate the followings:

When the results in Examples 3 to 7 were compared with those in Comparative Examples 2 and 3, wherein the samples in Examples 3 to 7 were deposited with an antibacterial agent polyhexamethylene biguanidine hydrochloride salt, while the samples in Comparative Examples 2 and 3 were deposited with a general antibacterial agent silver-containing zeolite or the like, the wefts deposited with polyhexamethylene biguanidine hydrochloride salt in Examples 3 to 7 were superior in hairdressing properties and had a high bacteriostatic activity of 4.9 to 6.0, while the wefts deposited with a general antibacterial agent in Comparative Examples 2 and 3 were significantly inferior in appearance (precipitation of white powder) or hairdressing properties (lower combing property and tacky touch feeling).

Alternatively when the results in Example 11 is compared with those in Comparative Example 7, wherein the weft of Example 11 was coated under a condition similar to that above except that a silicone was used as the textile-processing agent and the weft of Comparative Example 7, except that a general textile-processing agent surfactant was used, the weft of Example 11 was superior in hairdressing properties and had a bacteriostatic activity of as high as 5.6, while the weft of Comparative Example 7 was superior in hairdressing properties, but had a low bacteriostatic activity of 0.3, indicating that the antimicrobial activity decreased significantly after shampooing.

Alternatively when the results in Examples 1, 2, and 6 were compared, wherein the artificial hair fibers prepared under a condition similar to that above except that the drying temperature of the aqueous solution of the antibacterial agent was altered were evaluated, the artificial hair fiber of Example 1 processed at a temperature of 60° C. had a bacteriostatic activity of 3.8; that of Example 2 processed at a drying temperature of 90° C., a bacteriostatic activity of 4.6; and that of Example 6 processed at a drying temperature of 110° C., a bacteriostatic activity of 6.0, revealing that the antimicrobial activity increased along the heightening of the drying temperature. Alternatively when the results in Examples 6 and 8 are compared, wherein the artificial hair fibers prepared under a condition similar to that above except that the heating periods were changed respectively to 60 and 30 minutes were evaluated, the artificial hair fiber heated for a longer period in Example 6 had a bacteriostatic activity higher than that heated for a shorter period in Example 8. These results seem to suggest that the silicone and the polyhexamethylene biguanidine hydrochloride salt react to each other, for example, chemically by heat treatment.

As shown in Examples 12 to 14, a fiber bundle in combination of the artificial hair fiber according to the present embodiment and an artificial hair fiber not deposited with an antimicrobial also shows a sufficient antimicrobial activity.

The results in the Examples above showed that the artificial hair fiber according to the present embodiment had various favorable properties.

As described above, an aspect of the invention is directed to an artificial hair fiber comprising a synthetic fiber, the synthetic fiber is coated with a silicone, and at least one guanidine salt compound selected from polyhexamethylene biguanidine salt and polyhexamethylene guanidine salt is deposited on a surface of the silicone. The artificial hair fiber thus prepared by depositing the guanidine salt compound on the surface of the silicone-coated synthetic fiber is resistant to the deterioration in antimicrobial activity caused by shampooing and superior in combing property and touch feeling.

Preferably, the synthetic fiber may be a fiber selected from polyester fiber, polyamide fiber, polyvinyl chloride fiber, and acrylic fiber, because it is also possible to provide the artificial hair fiber having favorable touch feeling and appearance similar to those of natural hair and superior in combing property and curling efficiency.

Preferably, the guanidine salt compound may be deposited in an amount of 0.001 to 1% omf, because the resulting artificial hair fiber is resistant to the deterioration in antimicrobial activity by shampooing and has further improved durability of antimicrobial activity.

Preferably, the silicone may be coated in an amount of 0.01 to 0.5% omf, because it is possible to provide the artificial hair fiber especially superior in touch feeling and combing property.

Preferably, a ratio of the amount by mass of the silicone to that of the guanidine salt compound (guanidine salt compound/silicone) may be 0.01 to 25, because the resulting artificial hair fiber has particularly favorable durability of antimicrobial activity.

The silicone may be preferably at least one silicone selected from dimethyl silicone and amino-modified silicones, from the point that the artificial hair fiber therefrom is superior in touch feeling and combing property and also in the durability of antimicrobial activity.

Another aspect of the invention is directed to an artificial hair fiber bundle comprising the artificial hair fibers. The artificial hair fiber bundle is used favorably as a material for producing hair decorative products superior in antimicrobial durability, as the artificial hair fiber according to the present invention is used alone or in combination with other synthetic or natural fiber for various hair decorative products.

Another aspect of the invention is directed to the hair decorative product obtained by sewing the artificial hair fiber bundles. The hair decorative product is superior in antimicrobial durability and also in combing property and touch feeling.

Yet Another aspect of the invention is directed to a process for a preparation of an artificial hair fiber comprising a synthetic fiber, including the steps of: coating on the synthetic fiber with a silicone, and depositing on the silicone-coated synthetic fiber with at least one guanidine salt compound selected from polyhexamethylene biguanidine salt and polyhexamethylene guanidine salt.

Preferably, the step of depositing on the silicone-coated synthetic fiber with the guanidine salt compound includes a step of coating on the silicone-coated synthetic fiber with an aqueous solution of the guanidine salt, and a step of drying the fiber by heating.

The heating temperature for the step of drying the fiber depends on the kind of the synthetic fiber used and is not particularly limited, but is preferably approximately 50 to 170° C., more preferably 80 to 150° C., from the points that it is possible to remove water without damaging the fiber and that the durability of antimicrobial activity of the resulting fiber is better. In the case that the synthetic fiber is a polyester fiber, the heating temperature for the step of drying may be preferably 90 to 150° C. While the synthetic fiber is an acrylic fiber, the heating temperature for the step of drying may be preferably 80 to 100° C.

### INDUSTRIAL APPLICABILITY

The present invention provides an artificial hair fiber having favorable combing property and touch feeling and resistant to the deterioration of antimicrobial activity by shampooing, and an artificial hair fiber bundle and a hair decorative product using the same.

What is claimed is:

1. An artificial hair fiber comprising a synthetic fiber, wherein the synthetic fiber is coated with a silicone and at least one guanidine salt compound selected from polyhexamethylene biguanidine salt and polyhexamethylene guanidine salt is deposited on a surface of the silicone.

2. The artificial hair fiber according to claim 1, wherein said synthetic fiber is a fiber selected from polyester fiber, polyamide fiber, polyvinyl chloride fiber, and acrylic fiber.

3. The artificial hair fiber according to claim 1, wherein said guanidine salt compound is deposited in an amount of 0.001 to 1% omf.

4. The artificial hair fiber according to claim 1, wherein said silicone is coated in an amount of 0.01 to 0.5% omf.

5. The artificial hair fiber according to claim 1, wherein a mass ratio of an amount of said silicone to that of said guanidine salt compound (guanidine salt compound/silicone) is 0.01 to 25.

6. The artificial hair fiber according to claim 1, wherein said silicone is at least one silicone selected from dimethyl silicone and amino-modified silicones.

7. An artificial hair fiber bundle comprising the artificial hair fibers according to claim 1.

8. A hair decorative product obtained by sewing the artificial hair fiber bundles according to claim 7.

9. A process for a preparation of an artificial hair fiber comprising a synthetic fiber, including the steps of: coating on the synthetic fiber with a silicone, and depositing on the silicone-coated synthetic fiber with at least one guanidine salt compound selected from polyhexamethylene biguanidine salt and polyhexamethylene guanidine salt.

10. The process according to claim 9, wherein the step of depositing on the silicone-coated synthetic fiber with the guanidine salt compound includes a step of coating on the silicone-coated synthetic fiber with an aqueous solution of guanidine salt, and a step of drying the fiber by heating.

11. The process according to claim 10, wherein the synthetic fiber is a polyester fiber, and a heating temperature for the step of drying is 90 to 150° C.

12. The process according to claim 10, wherein the synthetic fiber is an acrylic fiber, and, a heating temperature for the step of drying is 80 to 100° C.
